(19) United States
(12) Patent Application Publication
(10) Pub. No.: US 2018/0092309 A1
(43) Pub. Date: Apr. 5, 2018

(54) DOUBLE-WALLED PLANT PROTECTOR

(71) Applicant: Demetrios Agathangelides, Gilbert, AZ (US)

(72) Inventor: Demetrios Agathangelides, Gilbert, AZ (US)

(21) Appl. No.: 15/722,352

(22) Filed: Oct. 2, 2017

Related U.S. Application Data
(60) Provisional application No. 62/402,756, filed on Sep. 30, 2016.

(51) Int. Cl. A01G 13/04; A01G 13/02

(52) U.S. Cl. CPC A01G 13/04; A01G 13/0243; A01G 13/0225

(57) ABSTRACT

A plant protector can includes an inner wall, an outer wall, and a lid coupled with the inner wall. The plant protector can further include a temperature sensitive coil coupled with the lid, wherein a change in external temperature can cause a change in the configuration of the temperature sensitive coil, causing the lid to transition between a closed position and an open position.

### INCORPORATION BY REFERENCE TO ANY PRIORITY APPLICATIONS

This application claims priority to U.S. Provisional Patent Application Ser. No. 62/402,756 filed on Sep. 30, 2016 and entitled “DOUBLE-WALLED PLANT PROTECTOR”, the content of which is hereby incorporated by reference in its entirety.

### BACKGROUND OF THE INVENTION

### Field of the Invention

This invention relates to agricultural equipment, and more particularly, relates to devices for protecting plants and facilitating growth in adverse conditions.

### Description of the Related Art

Climate conditions, such as low temperatures, high temperatures, changes in temperature, frost, or high winds, can be detrimental to plant health and growth. Wax paper cones can be placed over plants or seeds to partially protect against some adverse climate conditions, such as low temperatures, frost, or rain. Other products used for compensating for climate conditions use multiple layers, including a water layer, to provide additional insulation for a plant or seed. While such devices may protect against cold weather and other climate conditions, such devices are not capable of protecting a plant over large ranges of temperature without human interaction.

### SUMMARY OF THE INVENTION

In accordance with one aspect of the present invention, a plant protector is provided.

In one embodiment, a plant protector includes an inner wall, a lid coupled with the inner wall, wherein the lid and inner wall form an interior chamber when the lid is in a closed position, and a temperature sensitive coil or other actuator coupled with the lid, wherein the temperature sensitive coil is configured to change configuration based on a change in external temperature, wherein the temperature sensitive coil is configured to cause the lid to transition between an open position and a closed position based on the change in external temperature. A plant protector can also include an outer wall, wherein the inner wall and outer wall define a chamber configured to receive a liquid.

### BRIEF DESCRIPTION OF THE DRAWINGS

FIG. 1 shows a perspective view of a double-walled plant protector 100 in accordance with an illustrative embodiment of the present invention.

FIG. 2 shows the double-walled plant protector 100 having the outer wall 110 removed.

FIG. 3 shows a perspective view of the double-walled plant protector 100 from a different angle in comparison to FIG. 1.

FIG. 4 shows an exploded view of the double-walled plant protector 100.

FIG. 5 shows a cross-sectional view of the double-walled plant protector 100.

FIG. 6 shows a top view of the double-walled plant protector 100.

FIG. 7 shows a bottom view of the double-walled plant protector 100.

FIG. 8 shows a sectional view of the double-walled plant protector 100 showing an interface between the bottom section 130 and the top section 135.

FIG. 9 shows a sectional view of the double-walled plant protector 100 showing an interface between the outer wall 110 and the bottom section 130 of the inner wall 105.

FIG. 10 shows a sectional view of the double-walled plant protector 100 showing an interface between the outer wall 110 and the top section 135.

FIG. 11 shows a section view of the double walled plant protector 100 showing the recess 170.

FIG. 12 shows a coil 180 that can act as a mechanism for rotating the rod 125 and opening the lid 115.

### DETAILED DESCRIPTION OF THE PREFERRED EMBODIMENT

The present invention provides systems and apparatuses for protecting plants. Representative embodiments can include a double-walled plant protector configured to be placed over a seedling or plant.

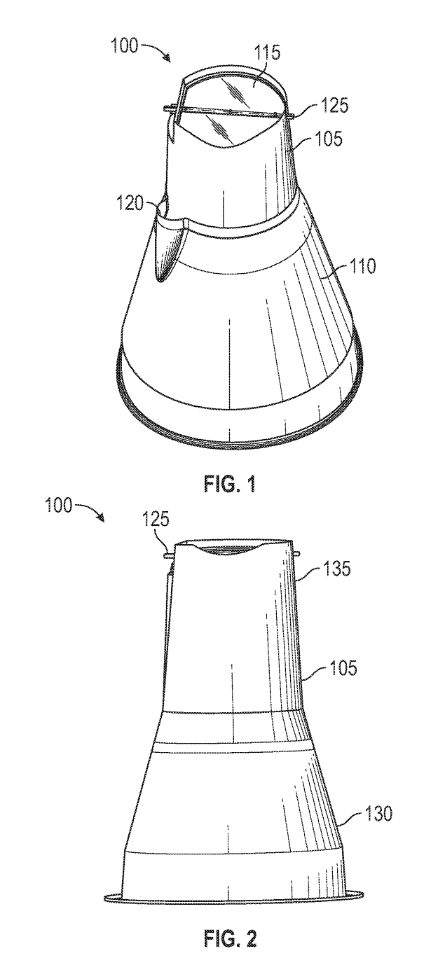

FIG. 1 shows a perspective view of a double-walled plant protector 100 in accordance with an illustrative embodiment of the present invention. The double-walled plant protector 100 includes an inner wall 105, and outer wall 110, and a lid 115. The outer wall 110 preferably includes a filling channel 120. A rod 125 extends horizontally through an upper section of the inner wall 105 and is attached to the bottom surface of the lid 115. FIG. 1 shows the lid 115 in a closed position. In accordance with an illustrative embodiment, the rod 125 is configured to rotate about its long axis, causing the lid 115 to rotate about the long axis of the rod. The double walled plant protector 100 is configured to be positioned over a seedling or plant. FIG. 1 shows the lid 115 is a closed position. Preferably, on one side of the rod 125, a lower surface of the lid 115 rests against an upper side of a surface of the plant protector 100, while on the other side of the rod 115, an upper surface of the lid 115 rests against a lower surface of a structure at the top of the plant protector 100, so that the lid can only rotate in one direction from the closed position to the open position. The lid 115 can rotate to an open position in order to allow outside air or sunlight to reach the interior of the plant protector 100. In certain embodiments, the lid 115 can rotate between about 0° and about 90° from the closed position shown in FIG. 1, from a fully closed position to a fully open position. As can be appreciated, when the lid 115 is fully open with the plane defined by the lid 115 extending vertically, a relatively large opening is produced with only the thickness of the lid 115 as a barrier, and with only a 90 degree rotation, the lid 115 is fully closed and seated against surfaces at the top of the plant protector in a manner to allow only minimal air leakage.

FIG. 2 shows the double-walled plant protector 100 having the outer wall 110 removed. As shown in FIG. 2, the inner wall 105 includes a top section 135 and a bottom section 130.

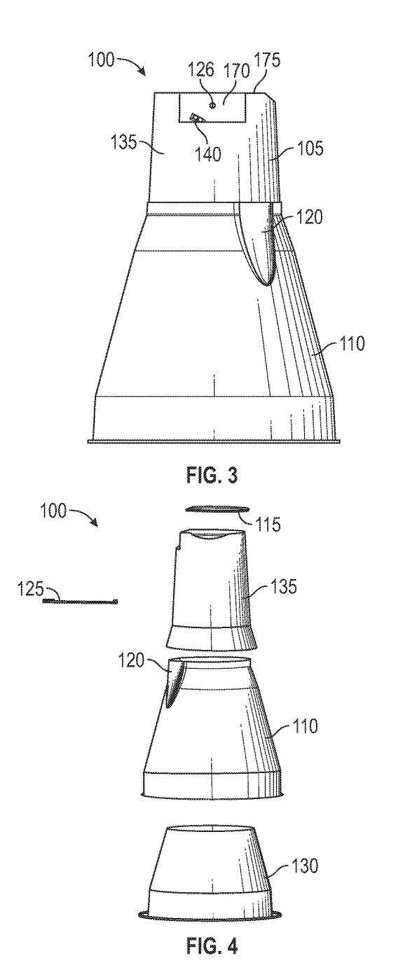

FIG. 3 shows a perspective view of the double-walled plant protector 100 from a different angle in comparison to FIG. 1. As shown in FIG. 3, the double-walled plant protector 100 includes recess 170 near the proximal end 175 of the top section 130. Extending outward from the recess 170 is a pair of protrusions 140 and a first end 126 of the rod 125. As will be discussed in further detail below, the pair of protrusions 140 can be configured to receive and secure a mechanism for rotating the rod 125 and opening the lid 115.

FIG. 4 shows an exploded view of the double-walled plant protector 100.

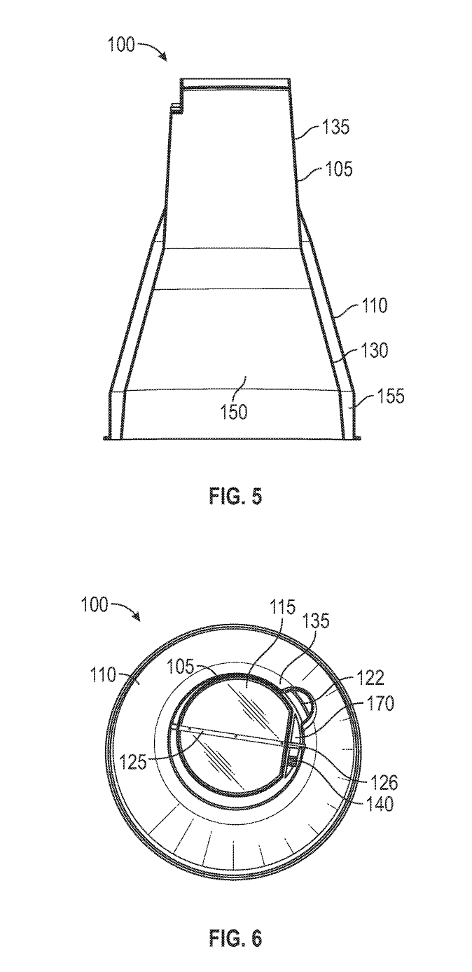

FIG. 5 shows a cross-sectional view of the double-walled plant protector 100. The interior surface of the inner wall 105 defines an interior chamber 150 configured to be positioned over a seedling or plant. When the lid 115 is in the closed position, the interior surface of the lid 115 can act as a seal for the interior chamber 150 of the plant protector 100. The interior surface of the outer wall 110 and the exterior surface of the inner wall 105 define a chamber 155. The chamber 155 is configured to receive contents introduced into the filling channel 120. In some embodiments, the filling channel 120 can receive a fluid, such as water, which can at least partially fill the chamber 155.

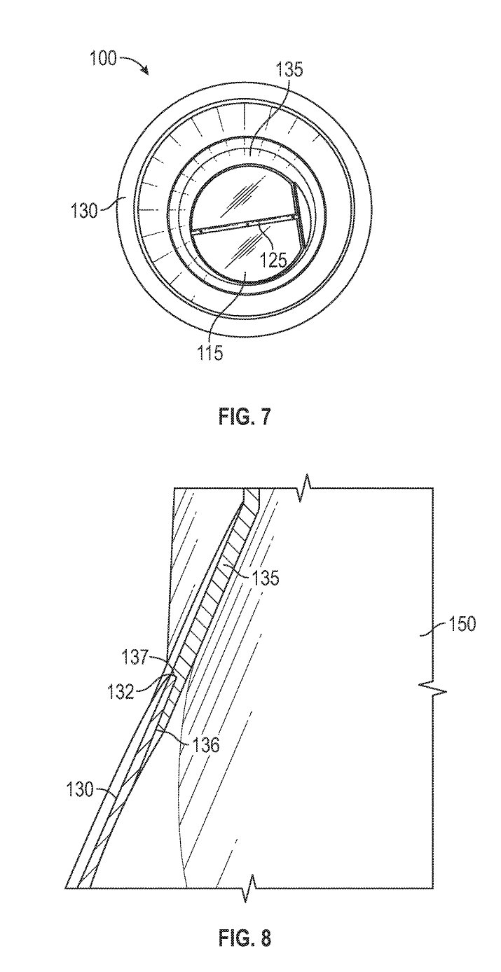

FIG. 6 shows a top view of the double-walled plant protector 100. FIG. 6 shows an opening 122 of the filling channel 120, through which fluids can be introduced. FIG. 7 shows a bottom view of the double-walled plant protector 100.

FIG. 8 shows a section view of the double-walled plant protector 100 showing an interface between the bottom section 130 and the top section 135. At the interface, a proximal end 132 of the bottom section 130 engages a recessed edge 137 of the top section 135. The recessed edge 137 is located proximally to a distal end 136 of the top section 135. The distal end 136 of the top section 135 is located interiorly to the proximal end 132 of the bottom section 130. The interface may be airtight or watertight. This interface can be configured to prevent fluid in the chamber 155 from entering the interior chamber 150 of the plant protector 100. The interface may be configured to prevent the dissipation of heat from the plant protector 100. In one embodiment the fluid has a high thermal mass and preferably a high latent heat of fusion. Water is a preferred embodiment of the fluid.

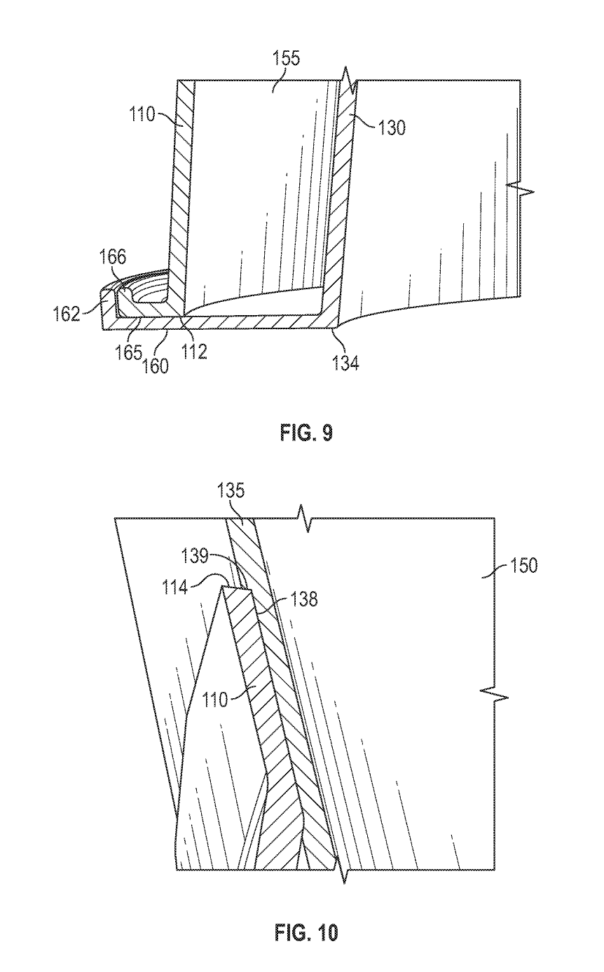

FIG. 9 shows a sectional view of the double-walled plant protector 100 showing an interface between the outer wall 110 and the bottom section 130 of the inner wall 105. The lower section 130 includes a base plate 160 extending outwardly at the distal end 134 of the bottom section 130. A lip 162 positioned at the exterior edge of the base plate 160 curls upward in the proximal direction. The outer wall 110 includes a base plate 165 extending outwardly at the distal end 112 of the outer wall 110. A lip 166 positioned at the exterior edge of the base plate 165 extends upward in the proximal direction. A bottom surface of the base plate 165 engages a top surface of the base plate 160. The exterior surface of the lip 166 engages the interior surface of the lip 162. In some embodiments, the exterior surface of the lip 166 is secured to the interior surfaced of the lip 162 via an interference fit, and may optionally be secured by an adhesive, solvent welding, ultrasonic welding, RF welding, or other suitable fastening technique. The interface between the outer wall 110 and the bottom section 130 of the inner wall 105 can be configured to be airtight or watertight so that fluid in the chamber 155 is prevented from leaking out of the interface. The interface may be configured to prevent the dissipation of heat from the plant protector 100.

FIG. 10 shows a sectional view of the double-walled plant protector 100 showing an interface between the outer wall 110 and the top section 135. The top section includes a recess 138 having an edge 139 at the proximal end of the recess 138. The proximal end 114 of the outer wall 110 is configured to fit within the recess 138 and engage the edge 139. When the proximal end 114 of the outer wall 110 is positioned within the recess 138, an interior surface of the outer wall 110 near the proximal end 114 can engage an exterior surface of the top section 135. In some embodiments, the interior surface of the outer wall 110 near the proximal end 114 may be secured to the exterior surface of the top section 114 through an interference fit, optionally welded or glued to form a permanent bond and seal. The interface between the outer wall 110 and the top section 135 may be airtight or watertight. The interface may be configured to prevent the dissipation of heat from the plant protector 100.

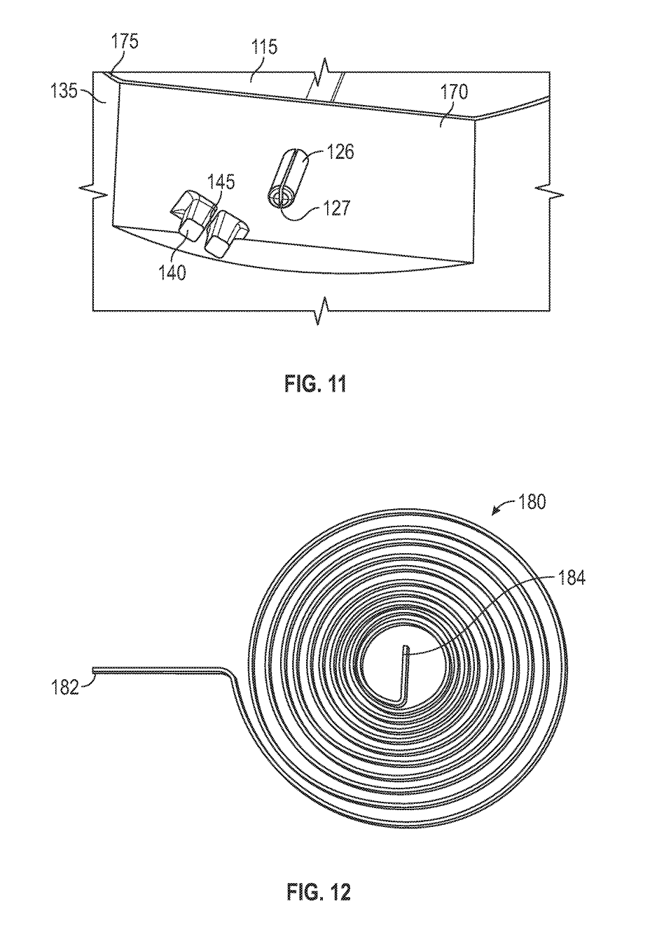

FIG. 11 shows a section view of the double walled plant protector 100 showing the recess 170. The protrusions 140 are spaced apart so as to form a slot 145 therebetween. The first end 126 of the rod 125 also includes a slot 127. The slot 145 and slot 127 can be configured to receive and secure a mechanism for rotating the rod 125 and opening the lid 115.

FIG. 12 shows a coil 180 that can act as a mechanism for rotating the rod 125 and opening the lid 115. A first end 182 of the coil 180 can be configured to fit within the slot 145 formed by the protrusions 140. A second end 184 of the coil 180 can be configured to fit within the slot 127 of the rod 125. In certain embodiments, the coil may be temperature sensitive, such that the coil 180 can change configurations in response to changes in temperature. In some embodiments, the coil 180 consists of a bimetallic strip. The coil 180 may be configured such that increases in temperature above a particular threshold temperature will cause the second end 184 to rotate about a central axis, which, while the second end 184 is positioned within the slot 127, can cause the rod 125 to rotate along the long axis of the rod 125, causing the lid to rotate from a closed position to an open position.

When the lid is in an open position, a decrease in temperature can cause rotation of the end 184 in an opposite direction of that described for an increase in temperature, causing the lid to rotate towards the closed position. If the temperature decreases to the particular threshold temperature, the lid can return to the closed position. For example, the lid can start to open when the interior temperature is above about 50, 55, 60, 65, 70, 75, or 80 degrees F., and can be fully open at a temperature of about 2, 3, 4, 5, 7, 10, 15, 20, or 25 degrees higher than that. Because transparent enclosures can trap solar heat through the greenhouse effect, the interior temperature can be significantly higher than the exterior temperature. While this extra heat can facilitate plant growth when it is cold outside, it can damage plants if it gets too high. Thus, the ability of the lid 115 to fully open leaving an essentially unobstructed path for hot air to escape protects the plants from heat damage.

In certain embodiments, one or more of the components of the double-walled plant protector 100, such as the outer wall 110, inner wall 105, top section 135, bottom section 130, and lid 125, can be made of a transparent or semi-transparent material. One or more components of the plant protector 100 can consist of a material that is transparent or relatively transparent to photosynthetically-active radiation. Photosynthetically-active radiation describes wavelengths of light capable of being absorbed by plants, generally in the range of about 400 nm to 700 nm. In some embodiments, one or more components of the plant protector 100 can consist of a material that is relatively transparent or partially relatively transparent to a range of light extending from about 400 nm to 700 nm or a section of a range of light within the range of 400 nm to 700 nm. Chlorophyll a has absorption peaks at about 460 nm and 660 nm, while chlorophyll b absorbs at slightly higher wavelengths. The material making up one or more of the components of the plant protector 100 preferably have high transmissivity at the absorption maxima of chlorophylls a and b. Thus, the materials making up light-transmitting portions of the plant protector 100 preferably can transmit at least about 60, 65, 70, 75, 80, 85, 90 or 95 percent of solar radiation at the photosynthetically-active wavelengths.

In some embodiments, one or more of the components of the double-walled plant protector 100 can include one or more plastics.

Embodiments of a double-walled plant protector 100 as described above may assist in fostering an environment that is beneficial for plant growth, particularly in climates experiencing temperature changes, low temperatures, high temperatures, frost, rain, wind, or other potentially adverse climate conditions. For example, the inner wall 105, outer wall 110, and lid 115 when in the closed position can block wind, frost, rain, or other natural phenomena from contacting a plant or seedling positioned in the interior chamber 150 of the plant protector 100. The inner wall 105, outer wall 110, and lid 115 may also protect against animal interference with a plant or seedling positioned in the interior of the plant protector 100. The greenhouse effect can provide extra heat inside the plant protector 100 during cooler weather.

The chamber 155 is also configured to be filled with a liquid, such as water, through the filling channel 120. The water can provide insulation and thermal mass and act as a barrier to cold temperatures. Due to its specific heat, after warming during the day the water cools more slowly than the ambient air, keeping the plants warmer through its thermal mass. During freezing, due to the latent heat of fusion, liquid water remains at a constant temperature (the freezing point of 32° F. or 0° C.) until all of the water has crystalized to form ice. This is a slow process and even if the ambient temperature is several degrees below freezing, the water will not all freeze and thus the interior temperature of the plant protector 100 is unlikely to go below freezing. However, if all of the water has formed ice, the temperature of the ice may continue to decrease until it reaches the temperature of the outside air. The additional time required for the water in the chamber 155 to crystallize before dropping below the freezing temperature can act to prevent low night temperatures from damaging plants or seedlings. Energy from the sun may also be stored in water in the chamber 155. This stored energy may be transferred to the interior chamber 150 at night providing further heat for a plant or seedling in the interior chamber 150.

The lid 115 can be transitioned between a closed position and an open position. In the closed position, the lid 115 can form a seal at the top of the interior chamber 150 in order to retain heat within the interior chamber 150 and to block climate conditions such as frost, rain, wind, and low temperatures. In an open position, the lid 115 can be configured to allow light, heat, and air to enter the interior chamber 150. The coil 180 in connection with the rod 125 can function to open the lid 115 when the external temperature is above a threshold temperature, for example 65° F., and to close the lid 115 when the external temperature is below the threshold temperature. By transitioning the lid 115 between an open position and a closed position based on temperature, the coil 180 allows the plant protector 100 to automatically regulate the temperature within the interior chamber 150 without the electronic or manual input. The temperature sensitive coil 180 can cause the lid 115 to be in an open position when experiencing warm external temperatures, which may occur during the day when sunlight is radiating on the plant protector 100, further allowing sunlight to enter the top of the interior chamber 150 and allowing heat to enter the interior chamber 150. In some embodiments, the opening of the lid 115 may also prevent the interior chamber 150 from experiencing temperatures that are too warm to sustain plant growth by allowing for the release of heat. The temperature sensitive coil 180 can also cause the lid 115 to transition to the closed position when experiencing cold external temperatures. For example, when the temperature drops at night, the temperature sensitive coil 180 may cause the lid 115 to transition to the closed position, sealing in heat remaining in the chamber and providing insulation against cold external temperatures and conditions. The advantages described above may extend the growing season of a plant or seedling by weeks or even a month or more in cooler climates.

Various other modifications, adaptations, and alternative designs are of course possible in light of the above teachings. Therefore, it should be understood at this time that within the scope of the appended claims the invention may be practiced otherwise than as specifically described herein. It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited. The methods disclosed herein include certain actions taken by a practitioner; however, they can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, and “substantially” as used herein include the recited numbers (e.g., about 10%=10%), and also represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

What is claimed is:

1. A plant protector comprising:
an inner wall;
a lid coupled with the inner wall, wherein the lid and inner wall form an interior chamber when the lid is in a closed position;
a temperature sensitive coil coupled with the lid, wherein the temperature sensitive coil is configured to change configuration based on a change in external temperature, wherein the temperature sensitive coil is configured to cause the lid to transition between an open position and the closed position based on the change in external temperature.

2. The plant protector of claim 1, further comprising an outer wall, wherein the inner wall and outer wall define a chamber configured to receive a liquid.

3. The plant protector of claim 1, further comprising a generally horizontal rod, wherein the lid is secured to the rod, wherein the rod comprises a slot, wherein an end of the temperature sensitive coil engages the slot, wherein the temperature sensitive coil is configured to cause the rod to rotate about a long axis of the rod based on the change in temperature, causing a plane defined by the lid to rotate from a generally horizontal orientation to a generally vertical orientation.

4. The plant protector of claim 2, wherein one or more of the inner wall, the outer wall, and the lid comprise a transparent or semi-transparent plastic.

5. The plant protector of claim 2, wherein one or more of the inner wall, the outer wall, and the lid are transparent or at least relatively transparent to light having wavelengths between 400 nm and 700 nm.

6. The plant protector of claim 2, further comprising a filling channel configured to receive liquid, wherein the chamber defined by the inner wall and the outer wall is configured to receive liquid from the filling channel.

7. The plant protector of claim 1, wherein the temperature sensitive coil is configured to cause the lid to transition to an open position when an external temperature is higher than a threshold temperature.

8. The plant protector of claim 1, wherein the temperature sensitive coil is configured to cause the lid to transition to a closed position when an external temperature is lower than a threshold temperature.

9. The plant protector of claim 1, wherein the inner wall further comprises a pair of protrusions configured to receive a second end of the temperature sensitive coil.

10. The plant protector of claim 7, wherein the threshold temperature is about 65° F.

11. The plant protector of claim 3, wherein the lid is configured to rotate from a horizontal to a vertical orientation about the long axis of the rod.

12. The plant protector of claim 11, wherein the lid is configured to rotate about 90° from the closed position to the open position.
